(19) United States
(12) Patent Application Publication
(10) Pub. No.: US 2003/0163745 A1
(43) Pub. Date: Aug. 28, 2003

(54) Method to reduce power in a computer system with bus master devices

(76) Inventor: James P. Kardach, Saratoga, CA (US)

Correspondence Address: David N. Tran, Blakely, Sokoloff, Taylor & Zafman LLP, Seventh Floor, 12400 Wilshire Boulevard, Los Angeles, CA, 90025-1030, US

(21) Appl. No.: 10/085,307

(22) Filed: Feb. 27, 2002

(51) Int. Cl. G06F 1/26; G06F 1/32

(52) U.S. Cl. 713/320

(57) ABSTRACT

A system memory accessed by a bus master controller is set as non-cacheable. A bus master status bit is not set for any bus master controller transfer cycles with the non-cacheable memory while the a system processor is in a low power state.

### FIELD OF THE INVENTION

The present invention relates generally to the field of power management. More specifically, the present invention relates to methods and systems for allowing processors to be placed in low power states.

### BACKGROUND

The Advanced Configuration and Power Interface (ACPI) specification defines a hardware and software environment that allows operating system (OS) software complete visibility and control of system configuration and power management. ACPI combines power management and plug and play functionality for computer systems. ACPI describes a set of valid processor operating states and the allowable transitions between them. The upper four states defined for the processor are C0, C1, C2, and C3. The C0 state is a normal operation state. The C1 state is low-power, low-latency state that assumes no support from chipset logic that retains all cached context. The C2 state is a lower-power, slightly longer latency state than C1 that requires chipset support but still retains cached context. The C3 state is a still lower power, longer latency state that also requires chipset support but one in which the cached context may be lost. Systems based on the IA-32 architecture typically map the use of the HALT (HLT) instruction to the C1 state, the STOPGRANT/QUICKSTART assertion to the C2 state, and Deep Sleep (removal of the processor clock input signal) operation to the C3 state. In the C1 and C2 states, the system processor can snoop the bus. In the C3 state, the system processor cannot snoop the bus.

In an ACPI-enabled OS, the OS needs to make a policy decision as to which low power state the processor should be placed in based on the input/output (I/0) activity and the available states of the processor and their attributes. To help the OS makes this policy decision, the ACPI system provides a bus master status (BM_STS) bit and an arbiter disable (ARB_DIS) bit. The ACPI system also provides control methods that describe the various available states of the processor. The BM_STS and ARB_DIS bits allow the OS to decide when to place the processor into the C3 state and when to place the processor into the much higher power C2 state.

The policy for deciding between the C2 or C3 low power states is based on the capabilities of the system in the C3 state. As mentioned previously the processor is incapable of snooping while in the C3 state, and additionally memory/cache coherency problems occur during bus master accesses. So the OS policy tracks the activity of bus master accesses via the BM_STS bit. If there is little activity, then it disables the bus arbiter (which prevents bus masters from executing) by setting the BM_STS bit and puts the processor into the C3 state.

Additionally the interval for which the OS determines the C2/C3 policy will affect the system's power performance. For an ACPI OS, the policy for determining the C-state of the processor is performed once every preempt interval. A preempt is defined as an interrupt generated by a periodic timer, also known as the timer interrupt. Typically this interval is on the order of 10 ms-20 ms (the interval is dependent of the OS). The processor schedules its work to be performed during this preempt time, and when the processor finishes this work it is placed into a low power state.

In placing the processor into the low power state, the OS looks at the remaining time in the preempt period, and the frequency of the bus master accesses. For entering a C3 state, the OS insures that the remaining preempt time is greater than the C3 exit latency, and then decides the likelihood of a bus master access for the remaining preempt time (by examining the BM_STS bit). If there is time for C3 exit and there has been no bus master activity then the OS will place the processor into the C3 state.

Thus, an idle low power system wishes to enter into the lowest power processor state possible (the higher the Cx state the lower the power, e.g. C3 is a much lower power state than C1). In addition, to enter the C3 state, the system must insure that there are no activities occurring that will affect the coherency of memory and/or caches as the processor is unable to snoop in this state. Furthermore, the policy for determining what Cx state occurs at least once per preempt interval, or on the order of once every 10 ms or so. These conditions define an idle C3 state. However, if there is something that causes cache coherency issues and occurs as frequently as the preempt interval, then the processor will never enter the C3 state. The OS tracks all cache coherency issues via the BM_STS bit, and the OS concludes that it can't enter a C3 state if the BM_STS bit is set.

### BRIEF DESCRIPTION OF THE DRAWINGS

The present invention is illustrated by way of example, and not limitation, in the figures of the accompanying drawings in which like references indicate similar elements and in which:

FIG. 1 is a block diagram illustrating an example of a computer system with non-cacheable memory in accordance to one embodiment of the present invention.

FIG. 2 is a block diagram illustrating an example of a computer system with write-through cacheable memory in accordance to one embodiment of the present invention.

### DETAILED DESCRIPTION

In one embodiment, a method that avoid setting the BM_STS bit to allow the processor to enter into the C3 state while maintaining memory coherency is disclosed. By changing caching policy of bus master buffers, many bus master activities do not create cache coherency issues and therefore need not be tracked by the BM_STS bit, thus allowing the processor to enter the C3 state more often.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Typically, the bus master status (BM_STS) bit is set with either a bus master read operation or write operation. For example, in a system with USB devices, a USB host controller reads descriptors from the memory to determine if there is any operation that the USB host controller needs to perform. Reading the descriptors from the memory occurs every millisecond. Most of the time the descriptors indicate that there is no operation for the USB host controller to perform. Traditionally, the BM_STS bit is set because the driver buffer is write-back cacheable, and thus if a bus master read operation is executed to a memory region where the actual data resides in the processor's cache, and the processor is in a C3 state, then bus master operation can't continue until the processor is awakened. This is because the processor is not able to service snoop cycles while in a C3 state. To prevent this situation, given any previous traffic that might cause a snoop cycle (BM_STS is set), the OS sets the ARB_DIS bit to prevent any bus master operation.

For a bus master write operation to a write-back cacheable memory area there is a chance that a copy of the memory area might reside within processor's cache. To maintain coherency, any bus master write operation to the write-through cacheable memory area needs to be snooped by the processor's cache. To prevent this situation the OS sets the ARB_DIS bit to prevent any bus master operation.

By creating design practices that avoid cache and memory coherency issues, the processor can be placed into a low power state. When the memory space used by the driver is marked and maintained as non-cacheable, memory coherency issues go away. Marking this memory space as non-cacheable assures that copies of this memory space are not present in the processor's cache and that there is no need to snoop the processor's cache for any bus master accesses by the device that uses this memory area. When the BM_STS is designed to NOT be set when a device generates bus master operations to the non-cacheable memory space, the OS can place the processor into the low power C3 state more often.

Alternatively, when the memory space used by the driver is marked and maintained as write-through cacheable, some of the memory coherency issues are resolved. Write-through cacheable memory means that there can be multiple copies of the data within the memory and processor cache, however both these copies are maintained coherent; any read operation just reads the local copy, while a write operation to a copy of this data must be copied to the other location (memory or cache). As such, bus master memory read operations do not require any interaction of the processor while bus master write operations to memory will require the processor's cache to be snooped (in order to update its copy of the data). For this type of configuration, where the bus master device's memory is marked as write-through cacheable, then the BM_STS bit could be designed to be set only when these devices generate bus master write accesses to write through memory areas. However bus master read accesses to write through cacheable memory areas do not need to set the BM_STS bit thus allowing the OS to place the CPU into the low power C3 state.

To optimize the entry of the C3 state, the following table illustrates how the BM_STS should be set depending on the cache ability of the memory area being accessed:

| | Current | Improved |
|---|---|---|
| Type of Bus Master Cycle | BM_STS | BM_STS |
| Memory Read Non-Cacheable Memory | Set | No change |
| Memory Write Non-Cacheable Memory | Set | No change |
| Memory Read Write-through Cacheable Memory | Set | No change |
| Memory Write Write-through Cacheable Memory | Set | Set |
| Memory Read Write-back Cacheable Memory | Set | Set |
| Memory Write Write-back Cacheable Memory | Set | Set |

As the table shows, making the bus master buffers non-cacheable totally avoids setting the BM_STS bit, while making bus master buffers write-through cacheable avoids setting the BM_STS bit for any read cycles. Depending on the behavior of the bus master, one of these techniques may be applied to allow the processor to enter into the C3 state more often.

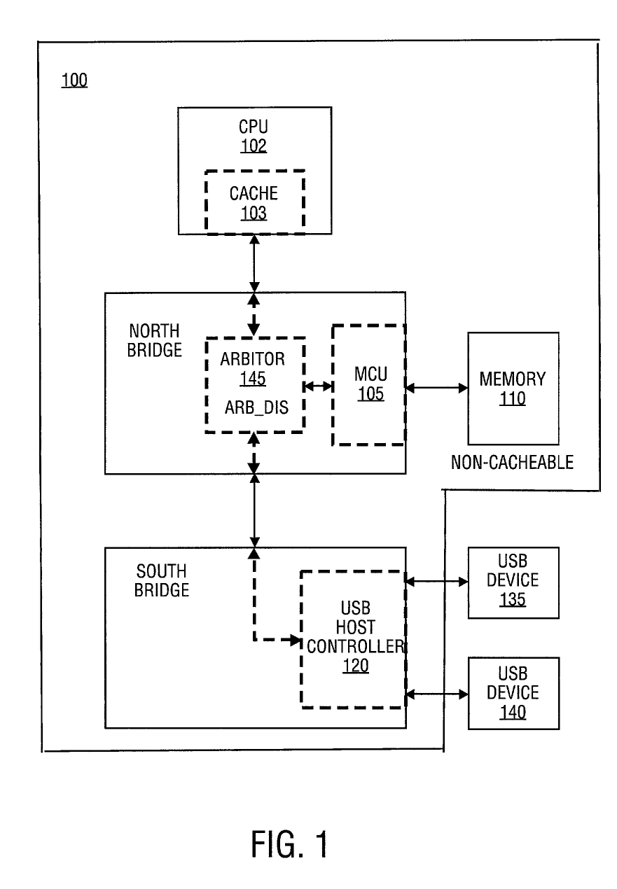

FIG. 1 is a block diagram illustrating an example of a computer system with non-cacheable memory in accordance to one embodiment of the present invention. The USB devices 135 and 140 are connected to the computer system 100 through a USB Host controller 120. The computer system 100 includes a processor 102, a memory controller unit (MCU) 105 and a memory 110. Typically, an OS in the computer system 100 schedules a periodic preempt interrupt at every time period (e.g., every 11 seconds). With each preempt interrupt, the OS schedules an amount of work for the processor 102 to do. When the processor 102 completes the work, the processor 102 is idled until a next preempt interrupt. The processor 102 then does some more work scheduled by the OS, and then the processor 102 is idle again.

When the processor 102 is idle, the OS puts the processor 102 into one of the low power states C1, C2, or C3, as described earlier. Each of these states has different attributes. For example, the C1 state is low power state of about 2 watts and has an exit latency of about 0.5 microseconds. The C2 state is a lower power state of about 1.5 watts and has an exit latency time of about 100 microseconds. The C3 state is a very low power state of about 0.2 watt and has an exit latency of approximately 3 microseconds. The C3 state is a very low power processor state. The exit latency time is the time it takes for the processor 102 to restart when there is a preempt interrupt.

Snooping is important in order to maintain coherency between the processor cache 103 and the memory 110. When the processor 102 is placed into the C3 state, the processor 102 cannot snoop the bus. For example, while the processor is in the C3 state, if the USB host controller 120 (or a bus master controller) was to take control of the bus and perform a data write into the memory 110, and the corresponding data happens to be in the processor cache 103, then there would be a memory coherency problem. The data in the memory 110 would be more recent than the data in the processor cache 103 but the processor 102 would not have noticed it because it cannot snoop the bus.

To prevent the memory coherency problem, the ACPI specification calls out that the bus master arbiter 145 is disabled. Disabling the bus master arbiter 145 is achieved by setting the arbiter disable (ARB_DIS) bit. This prevents the bus master arbiter 145 from granting the bus to any bus master controller (including the USB host controller) or devices. However, setting the ARB_DIS bit would interfere with the ability of the USB host controller 120 to read its frame lists. As described above, the USB host controller 120 frequently generates a bus master access to the memory 110 (e.g., every one millisecond).

In one embodiment of the present invention, the portion of memory 110 used by the bus master device is set as non-cacheable, and the BM_STS bit is not set for any bus master accesses made by the bus master device (USB host controller 120). This will cause the OS to ignore any bus master activity from this non-cacheable bus master device, and it will not influence the OS policy for placing the processor 102 in to the C3 state. For example, when the USB host controller 120 performs a bus master write operation to write into the non-cacheable memory 110, there is no cache coherency problem to worry about. When the USB host controller 120 performs a bus master read operation to read from the non-cacheable memory 110, there is no memory coherency problem. Thus, the processor 102 does not need to snoop the bus during any bus access by the USB host controller 120, and therefore can be placed in the low power C3 state.

To optimize this type of configuration, the MCU 105 needs to not issue snoop cycles to the processor 102 for any bus master accesses from the “non-cacheable” bus master device (USB host controller 120). There are many methods for performing this sort of memory typing. For example, memory attribute registers can be programmed into the MCU identifying which portions of memory are non-cacheable, or a separate signal from the bus master device could identify it as the originator of the bus cycle operation.

Further, because the “non-cacheable” bus master device (USB host controller 120) no longer generates cache coherency problems, and the MCU 110 no longer generates snoop cycles to the processor 102, the “non-cacheable” bus master device can be allowed to operate when the ARB_DIS bit is set (which would normally force all bus master devices to not operate). Note that this only applies to “non-cacheable” bus master devices, all other bus master devices that can create coherency issues need to be disabled when the ARB_DIS bit is set.

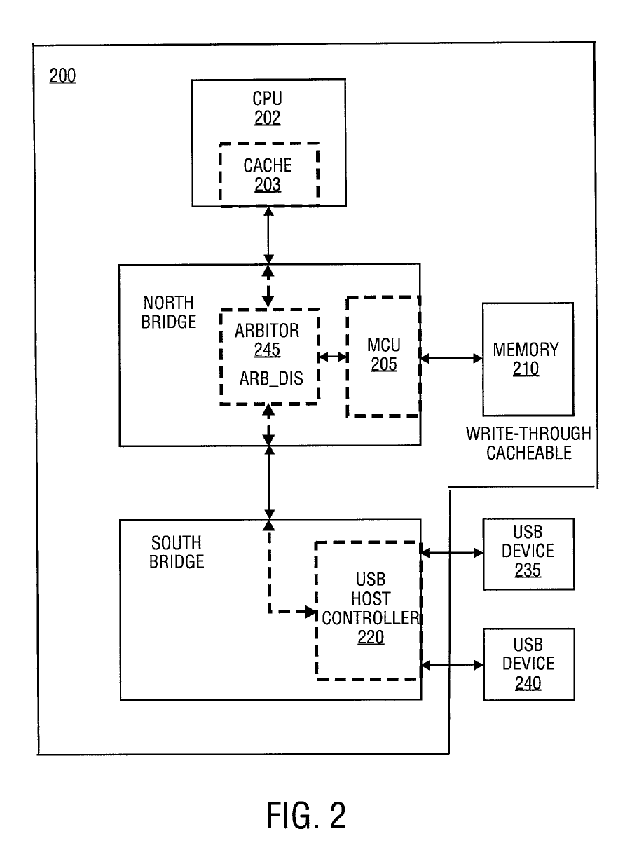

FIG. 2 is a block diagram illustrating an example of a computer system with write-through cacheable memory in accordance to one embodiment of the present invention. The memory 210 is set as write-through cacheable for the memory used by the bus master device (in this case the USB host controller 220), and the BM_STS bit is only set for bus master write operations from this “write-through cacheable” bus master device, but is not set during bus master read operations from this “write-through cacheable” bus master device. This allows the cache 203 and the memory 210 to be coherent with one another when there is a bus master write operation. Although the cache 203 is illustrated as a processor cache, this technique is also applicable to other cache implementation.

To optimize this type of configuration, the MCU 210 does not send snoop cycles to the processor 203 for any bus master read operations from this particular “write-through cacheable” bus master device (USB host controller 220). There are many methods for performing this sort of memory typing. For example, memory attribute registers can be programmed into the MCU identifying which portions of memory are write-through cacheable, or a separate signal from the bus master could identify it as the originator of the bus cycle operation.

Further because the “write-through cacheable” bus master device no longer generates cache coherency problems for memory read cycles, and the MCU 210 no longer generates snoop cycles to the processor 203 for bus master read operations from this “write-through cacheable” bus master device, the “write-through cacheable” bus master device can be allowed to perform bus master read operations when the ARB_DIS bit is set (which would normally force all bus master devices to not operate). This “write-through cacheable” bus master device still needs to be prevented from generating bus master write cycles when the ARB_DIS bit is set, however bus master read operations can continue. Note that this only applies to “write-through-cacheable” bus master devices; all other bus master devices that can create coherency issues need to be disabled when the ARB_DIS bit is set.

The operations of the various methods of the present invention may be implemented by a processing unit in a digital processing system, which executes sequences of computer program instructions. The operations may include hardware circuitry with an auxiliary processor dedicated to performing functions of power management. The operations may be performed using an application software including instructions that are stored in a memory, which may be considered to be a machine-readable storage media. The memory may be random access memory, read only memory, a persistent storage memory, such as mass storage device or any combination of these devices. Execution of the sequences of instruction causes the processing unit to perform operations according to the present invention. The instructions may be loaded into memory of the computer from a storage device or from one or more other digital processing systems (e.g. a server computer system) over a network connection. The instructions may be stored concurrently in several storage devices (e.g. DRAM and a hard disk, such as virtual memory). Consequently, the execution of these instructions may be performed directly by the processing unit.

In other cases, the instructions may not be performed directly or they may not be directly executable by the processing unit. Under these circumstances, the executions may be executed by causing the processor to execute an interpreter that interprets the instructions, or by causing the processor to execute instructions which convert the received instructions to instructions which can be directly executed by the processor. In other embodiments, hard-wired circuitry may be used in place of or in combination with software instructions to implement the present invention. Thus, the present invention is not limited to any specific combination of hardware circuitry and software, nor to any particular source for the instructions executed by the computer or digital processing system.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method, comprising:
setting a memory used by a bus master device as non-cacheable, the memory and the bus master device being in a computer system;
not setting a bus master status bit (BM_STS) for any bus master memory operation by the bus master device with the memory; and
placing the processor in the computer system into a low power state

2. The method of claim 1, wherein the low power state is a deep sleep state.

3. The method of claim 1, wherein the low power state is a C3 state.

4. The method of claim 1, wherein the memory is coupled to a memory subsystem which does not generate snoop cycles to the processor during any bus master accesses performed by the bus master device.

5. The method of claim 4, wherein the bus master device is allowed to generate bus master read and write operations when the ARB_DIS bit is set.

6. A computer readable medium having stored thereon sequences of instructions which are executable by a system, and which, when executed by the system, cause the system to perform a method, comprising:
setting a memory used by a bus master device as non-cacheable, the memory and the bus master device are in a computer system;
not setting a bus master status bit (BM_STS) for any bus master memory operation by the bus master device with the memory; and
placing the processor in the computer system into a low power state

7. The computer readable medium of claim 6, wherein the low power state is a deep sleep state.

8. The computer readable medium of claim 6, wherein the low power state is a C3 state.

9. The computer readable medium of claim 6, wherein the memory is coupled to a memory subsystem which does not generate snoop cycles to the processor during any bus master accesses performed by the bus master device.

10. The computer readable medium of claim 9, wherein the bus master device is allowed to generate bus master read and write operations when the ARB_DIS bit is set.

11. A system, comprising:
a memory set as non-cacheable;
a bus master device coupled to the memory; and
a processor coupled to the memory and the bus master device, wherein the processor is placed into a low power state while the bus master device performs memory operations with the non-cacheable memory and while a bus master status (BM_STS) bit is not set for these bus operations.

12. The system of claim 11, wherein the low power state is a deep sleep state.

13. The system of claim 11, wherein the low power state is a C3 state.

14. The system of claim 11, further comprising a memory subsystem coupled to the memory, wherein the memory subsystem does not generate snoop cycles to the processor during any memory operations performed by the bus master device

15. The system of claim 14, wherein the bus master device is allowed to generate bus master read and write operations when an arbiter disable (ARB_DIS) bit is set.

16. A method, comprising:
setting a memory used by a bus master device as write through-cacheable, the memory and the bus master device are in a computer system;
not setting the bus master status (BM_STS) bit while the bus master device performs memory read operations with the memory; and
placing the processor in the computer system into a low power state

17. The method of claim 16, further comprising setting the BM_STS bit while the bus master device performs memory write operations with the memory.

18. The method of claim 17, wherein the processor is not placed in the low power state while the bus master device performs memory write operations with the memory.

19. The method of claim 17, wherein the low power state is a C3 state.

20. The method of claim 16, wherein the memory is coupled to a memory subsystem which does not generate snoop cycles to the processor during any bus master read operations performed by the bus master device

21. The method of claim 20, wherein the bus master device is allowed to generate bus master read operations when the ARB_DIS bit is set

22. A computer readable medium having stored thereon sequences of instructions which are executable by a system, and which, when executed by the system, cause the system to perform a method, comprising:
setting a memory used by a bus master device as write-through-cacheable, the memory and the bus master device are in a computer system;
not setting a bus master status (BM_STS) bit while the bus master device performs memory read operations with the memory; and
placing a processor in the computer system into a low power state.

23. The computer readable medium of claim 22, further comprising setting the BM_STS bit while bus master device performs memory write operations with the memory.

24. The computer readable medium of claim 22, wherein the processor is not placed in the low power state while bus master device performs memory write operations with the memory.

25. The computer readable medium of claim 22, wherein the low power state is a C3 state.

26. The computer readable medium of claim 22, wherein the memory is coupled to a memory subsystem which does not generate snoop cycles to the processor during any bus master read accesses performed by the bus master device

27. The computer readable medium of claim 26, wherein the bus master device is allowed to generate bus master read operations when the ARB_DIS bit is set

28. A system, comprising:
a memory set as write-through cacheable;
a bus master device coupled to the memory; and
a processor coupled to the memory and the bus master device, wherein
the bus master is allowed to perform memory read operations while the processor is in a low power state without setting the bus master status (BM_STS) bit.

29. The system of claim 28, wherein the processor is not placed into the low power state while the bus master device performs memory write operations with the memory.

30. The system of claim 28, wherein the BM_STS bit is set while the bus master device performs the memory write operations with the memory.

31. The system of claim 28, wherein the low power state is a C3 state.

32. The system of claim 28, further comprising a memory subsystem coupled to the memory, wherein the memory subsystem does not generate snoop cycles to the processor during any bus master read operations performed by the bus master device.

33. The system of claim 32, wherein the bus master device is allowed to generate bus master read operations when the ARB_DIS bit is set.
